(19) United States
(12) Patent Application Publication
(10) Pub. No.: US 2012/0183735 A1
(43) Pub. Date: Jul. 19, 2012

(54) METHOD FOR MANUFACTURING NON-FLAT AGGLOMERATED STONE PRODUCTS

(76) Inventors: José Luís Ramón Moreno, Cantoria (Almeria) (ES); Salvador Cristóbal Rodríguez García, Cantoria (Alemria) (ES); Adrián Medina Jiménez, Cantoria (Almeria) (ES)

(21) Appl. No.: 13/387,433

(22) PCT Filed: Jul. 27, 2009
(86) PCT No.: PCT/ES09/70314

§ 371 Date: Mar. 30, 2012

(51) Int. Cl. B32B 3/00; B28B 1/093

(52) U.S. Cl. 428/156; 264/69

(57) ABSTRACT

The invention relates to a method for manufacturing non-flat agglomerated stone products, such as sinks, washbowls, etc., by means of vacuum vibrocompression. A mold into which a molding mass is discharged is used in the method. The method allows obtaining products with two or more differentiated colors.

### FIELD OF THE INVENTION

The present invention relates to the techniques used in the production of agglomerated products, and more particularly, it relates to a method for manufacturing non-flat agglomerated stone products by means of vacuum vibrocompression.

### BACKGROUND OF THE INVENTION

It is well known in the state of the art how to manufacture agglomerates of stone aggregates and, in particular, quartz agglomerates in the form of panels, slabs, etc, i.e., bodies considered to be flat by the persons skilled in the art.

A widespread use of these flat agglomerates is for their placement in kitchen counters, bathroom counters and work surfaces in general, given that they have a high scratch resistance, low water absorption and good chemical resistance, in addition to the large aesthetic variety which can be achieved in them. Furthermore, agglomerates of this type are also commonly used in covering floors and walls, their use being limited to indoor use. Furthermore, the state of the art comprises the international PCT application WO 2006/100321, belonging to Cosentino S. A., which describes the manufacture of elements of this type with special resins allowing the use thereof in outdoor environments.

An example of these stone agglomerates can be found on the market with the name “Bretonstone”, manufactured by means of the process belonging to the company Breton S.p.A. (Italy), in which the manufacture of the agglomerates, in the form of a panel or of a slab, starts from a mixture of aggregates with a known grain size and a polyester resin to which suitable additives have been incorporated. Particularly, once the manufacturing mass is perfectly homogenized, it is directly arranged on a belt, such that a carriage limits the perimeter for such mass to take the form of a panel. The amount of mass arranged is calculated according to the dimensions (surface area and thickness) of the panel which is to be manufactured.

Likewise, between the mass and the conveyor belt there is placed a separating element such as a paper, liquid silicone, elastomer or plastic, for example any protective plastic preventing the mass from adhering to the belt during the pressing would be valid. Additionally, a layer of any conventional wax or demolding agent which facilitates the demolding even more, silicone type demolding agents, for example, can be added on this separating element. Once the mass to be pressed is arranged on the belt, another separating element identical to the previous one is placed on the mass for the same purpose. The mass then passes to the pressing step; in it, the press is provided with a frame integral with the element exerting the pressure with the same measurements as the panel, to prevent the mass from extending and increasing in surface area during the pressing.

However, given the proliferation of materials of this type as kitchen and bathroom counters, and due to the fact that the chromatic range which can be reached in these agglomerates is very broad, the need has arisen to make kitchen sinks, bathroom washbowls, other kitchen or bathroom items or any other non-flat product with this same material, for the purpose of preventing an aesthetic rupture from occurring between the sink or washbowl and the counter, i.e., an aesthetically very attractive and harmonized effect is sought.

Up until now, only a slight curvature has been provided to the panels or slabs manufactured from non-flat stone agglomerates, as described in international patent application PCT/EP2006/050470, which describes the preparation of a Bretonstone type traditional composition which, after performing the pressing by vacuum vibrocompression, is placed on a curved mold (with a limited radius) so that the panel acquires said curvature. The resin is then hardened to obtain the end object.

In this case, the radius of curvature is obviously limited to the pressed material not breaking or cracking in the mold, since the resin has still not hardened. Consequently, the technique described in this document cannot be applied in the manufacture of three-dimensional objects such as sinks, in which there are horizontal, vertical and curved surfaces, and considering the fact that the three-dimensional object can have a size up to 10 times larger than a traditional panel which has a thickness of 3 cm.

For the previous reasons, up until now the only alternative, which is laborious, for manufacturing said non-flat products was to adhere pieces previously cut to size obtained from said agglomerate in the form of a panel or of a slab. Subsequently, when the pieces are joined, the product is edge-planed and polished, as described in Spanish patent application 2 257 912 of Artemármol Chiclana (Spain).

In this sense, it is suitable to emphasize that the fact of machining the cut pieces of the sink and then joining them has certain drawbacks, for example, the effects of the adhesion in the joints are detected with the naked eye despite using colored putties or adhesives; furthermore, given that the sink or washbowl will continuously be subjected to contact with water, said joints are gradually deteriorated, color changes being observed therein.

Another option for manufacturing products with curved surfaces made of artificial stone is by means of injecting a mass into a mold. However, this technique requires, in the mass, a very high resin content (between 15-40% by weight of the total mass) so that the mass flows through the mold, since with the usual concentrations of resin in Bretonstone type formulations (6-13%) the mass does not flow and it is not possible to fill a mold either by pouring or by injection removing the occluded air. In addition to directly affecting the cost of the process, this increase in the resin content to achieve the suitable fluidity of the mass prevents performing chromatic effects such as two colors or three colors (introduction of several previously mixed masses with a different color, ES 2187313), since the excess of resin introduced to increase the fluidity of the mass entrains and mixes the colors, obtaining, instead of a mass with two or more differentiated colors, a mass of a single color “C” (which is the mixture of A+B) and not a element of two differentiated colors A and B.

For the same reasons described, materials with a veined effect, such as those described in the text of the international PCT application WO2006/134179, belonging to Cosentino S. A., cannot be obtained either, due to the fact that the dyes with which the vein effect is achieved are completely diluted in the polymer used as a binder and the effect disappears, diffuse areas with a different color appearing.

Another drawback of this method is that grain sizes greater than 2.5 mm cannot be used either because, in addition to the injection being rather difficult due to the increase of the mean size of the particles and the increase of the viscosity, due to the high percentage of resin, there is a decanting during the pressing, the method being limited to single colors with a fine grain (generally less than 2 mm).

### DESCRIPTION OF THE INVENTION

The object of the present invention is to provide a method which allows obtaining agglomerated stone products by means of vacuum vibrocompression.

Said object is achieved by means of a method in which, as an initial step, a mold which is open at the top and which has an inner surface is provided; the inner surface of the mold is subsequently covered with a material preventing the direct contact of the manufacturing mass with the mold, such as a demolding agent. Then, a molding mass consisting of particles of at least an aggregate and an organic binder is discharged into the mold.

The mold is subsequently subjected to vacuum for the purpose of extracting the occluded air in the mass; pressure and vibration are then applied to the mass to continue extracting the air and compacting the mass, which is then left to cure in order to harden the mass and, finally, the formed product is extracted.

In a preferred embodiment, the inner surface of the mold defines the shape of the non-flat product to be obtained and the mold is configured such that the product is shaped in a reverse manner inside the mold.

In another embodiment, the method additionally comprises the step of calibrating and polishing the obtained product after it is extracted.

In an additional embodiment, the mold additionally comprises a rigid inner sleeve which is placed and adjusted inside the mold; and on which the demolding agent is placed. The advantage of this embodiment is that once the vibrocompression has been performed, the sleeve is extracted from the mold to cure the mass inside it, the mold is thus free to be used again in obtaining another product.

The summary of the method for manufacturing non-flat agglomerated stone products comprises:

providing a mold which is open at the top and which has an inner surface;

covering the inner surface of the mold with a material preventing the direct contact of the manufacturing mass with the mold;

discharging a molding mass consisting of particles of at least an aggregate and an organic binder into the mold;

subjecting the mold to vacuum for the purpose of extracting the occluded air in the mass;

applying pressure and vibration to the mass to continue extracting the air and compacting the mass;

inducing the polymerization of the assembly; and,

extracting the formed product.

The non-flat agglomerated stone product obtained by that method is also an object of the invention, this product being able to be a kitchen or bathroom item or piece of furniture, including sinks, washbowls, shower trays, bathtubs or counters.

These products are suitable for indoor use or outdoor use, for which resins resistant to ultraviolet radiation, capable of withstanding the inclemency of the weather as well as the highest temperature variations when these products are placed outdoors should be chosen.

### BRIEF DESCRIPTION OF THE DRAWINGS

To complement the description which is being made and for the purpose of aiding to better understand the features of the invention according to preferred practical embodiments thereof, the following is attached as an integral part of this description:

FIG. 1 is a block diagram showing the sequence of a preferred embodiment of the method of the present invention.

FIG. 2 is a cross-sectional view of a mold used in a preferred embodiment of the present invention, in which the mold is empty.

FIG. 3 depicts the mold of FIG. 2 with the molding mass inside it.

FIG. 4 is a cross-sectional view of a mold used in an additional embodiment of the present invention in which the mold is empty.

### DETAILED DESCRIPTION OF THE PREFERRED EMBODIMENTS OF THE INVENTION

As described in the background section, up until now the vacuum vibrocompression method has only been useful for obtaining slabs and panels which are considered as flat products within the art and which are generally not more than 3 cm thick. Up until the present invention, it was considered that these principles were not applicable to non-flat products, such as sinks, which can be up to 40 cm high, i.e., more than 10 times the usual size of a panel or slab which usually do not exceed 3 cm, and which can have vertical walls, which is geometrically different from a panel with a horizontal surface.

The method of the present invention involves a significant change of concept and that change relates directly to the use of a mold in a vacuum vibrocompression machine which is resized to accept said mold, and performing therein and in the molding mass the vacuum, compression and vibration operations.

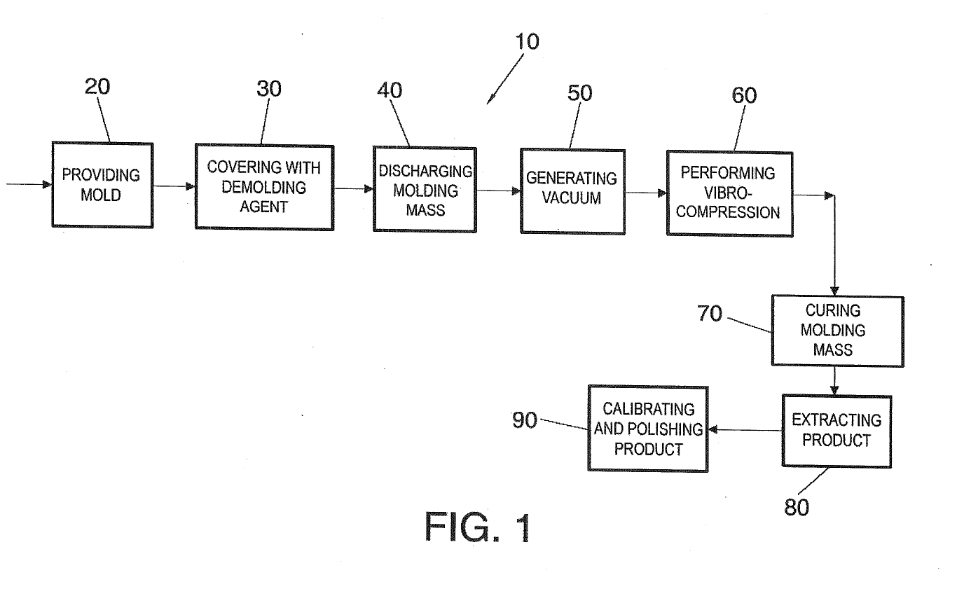

An embodiment of the method of the present invention can be explained from FIG. 1, in which the method 10 starts with step 20 in which a mold which is open at the top and which has an inner surface is provided. Then, in step 30 the inner surface of the mold is covered with a demolding agent. Subsequently, in step 40 a molding mass consisting of particles of at least a stone aggregate and an organic binder is discharged into the mold, the demolding agent prevents the mass from adhering to the mold and obviously facilitates demolding the obtained product.

Continuing with FIG. 1, after the mass has been discharged into the mold, step 50 is performed, in which the mold is subjected to vacuum for the purpose of extracting the occluded air in the molding mass; in this sense, the vibrocompression machines include a vacuum chamber, said chamber is sized so that the mold with the molding mass can be introduced therein.

Then, once the mold is inside the press and the required vacuum level, generally of the order of 1-20 mmHg, has been reached, the vibrocompression step 60 starts, said vacuum level being maintained simultaneously. The vibration and the compression must be transmitted to the entire molding mass to assure that the non-flat product is perfectly shaped and without porosity.

In relation to the mold, it can be constructed in any rigid material withstanding the mechanical stress involved in the vibrocompression step 60 which is performed in the order of 2 to 10 bar and with a vibration frequency of 2000 to 3500 rpm.

After applying this vibrocompression, the mold is extracted from the chamber, and the mass is left to cure in step 70, the curing time depends on the resin used, but it generally has a time of 1 to 5 hours. It is even possible to perform a much slower polymerization process by adjusting the catalysis system, such that process takes place for 3 or 4 days. Finally, after the polymerization step, the formed product is extracted from the mold in step 80.

In the embodiment which is described, an additional step which is indicated with reference number 90 is carried out, in which the product is calibrated and polished in all its inner faces, such that the material is provided with the desired end finish. This involves another substantial difference with the elements described in the state of the art, since the elements manufactured by means of injection are not polished, whereas the proposed elements are calibrated and polished, as occurs in flat parts.

In relation to the manufacturing mass used for the molding, using a conventional manufacturing mass, already described in the prior art, is preferred because the aesthetic characteristics desired in the product to be obtained must be exactly the same as those obtained in the pressed material in the form of a panel or slab. In said mass, a polyester, vinyl ester, polyurethane, epoxy or acrylic resin with a content of the order of 6 to 15% by weight in the molding mass is used, which is added in a mixture of different types of ground aggregates with known grain sizes and contents, such as quartz, cristobalite, siliceous sands, feldspar, granite, glass, ferrosilicon, metallic silica, mirror or other types of aggregates also described in the state of the art. Furthermore, pigments or coloring agents are also usually included so that the parts acquire the desired color.

The different grain sizes and contents of each of these aggregates depend on the end aesthetic appearance desired. Preferred grain sizes comprise a micronized material, with a mean particle size between 2 and 60 μm and ground materials the mean particle size of which is comprised between 0.065 mm and 8 mm. These aggregates can be of a different color, using at least two aggregates of a different color, and as a result of the method, colors, and not a single mixed color as in the prior art, can be differentiated in the end product. The aggregates used mixed with the resin and the pigments or coloring agents required can form manufacturing masses of different colors, and as a result of the method, these masses can be mixed without their colors being mixed, therefore different colors and not a single mixed color can be differentiated in the end product.

In order to harden the resin, suitable additives must be incorporated in the latter for which a catalyst and an accelerator, in addition to other additional additives such as coupling agents, coloring agents and pigments, antimicrobial additives and ultraviolet filters, among others, are used.

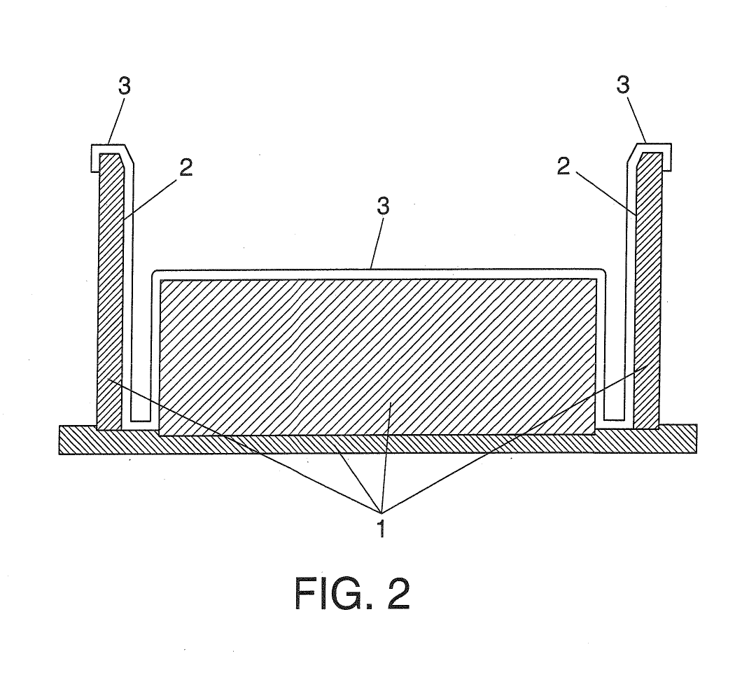

It is now suitable to refer to FIG. 2, which shows a sectional view of an occupied mold 1 in the method of the present invention, the mold has an inner surface 2 and is configured such that the product to be obtained is shaped in a reverse manner inside the mold 1. The inner surface 2 of the mold 1 is covered with a demolding agent, which in the described embodiment is a polymeric film 3.

Likewise, the demolding agent can be made of elastomeric materials, polymeric materials or of paper, or a liquid demolding agent; all of them prevent the direct contact of the manufacturing mass with the mold, which facilitates the extraction of the product. Furthermore, it is essential to prevent manufacturing mass from being introduced between the joints between walls of the metallic mold during the pressing step, because if the latter harden they make it impossible to be able to extract the product from the mold, hence the importance of the demolding film being perfectly adjusted to the mold, the film is preferably made of a single part having no internal joints. Of course, this does not limit the invention and only intends to illustrate a preferred mode of manufacture.

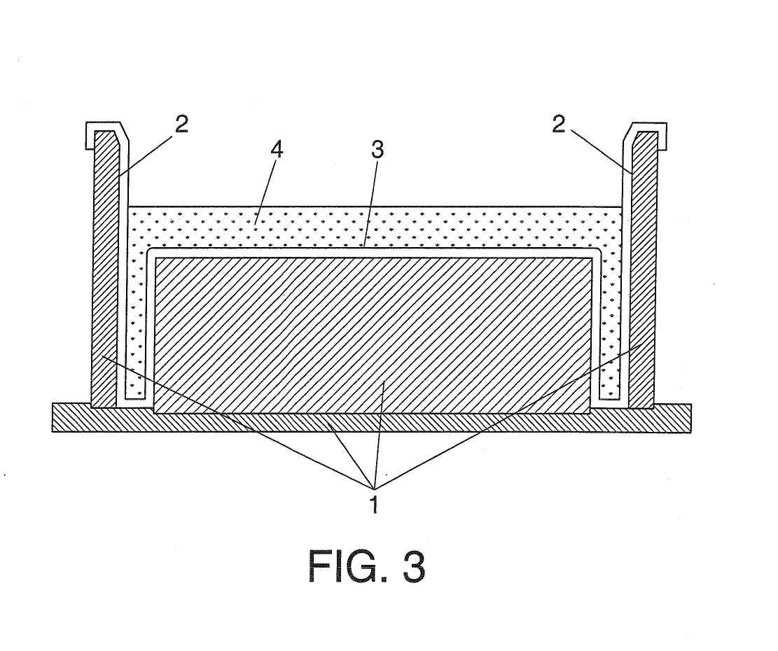

FIG. 3 shows the mold 1 with the molding mass inside it, in which the film 3 prevents the mass 4 from touching the inner surface 2 of the mold 1. In this embodiment, once the mass has been subjected to vacuum and the vibrocompression on the mass has been performed, such mass is cured inside the mold, the curing is performed inside an oven, and the formed product is then extracted from the mold.

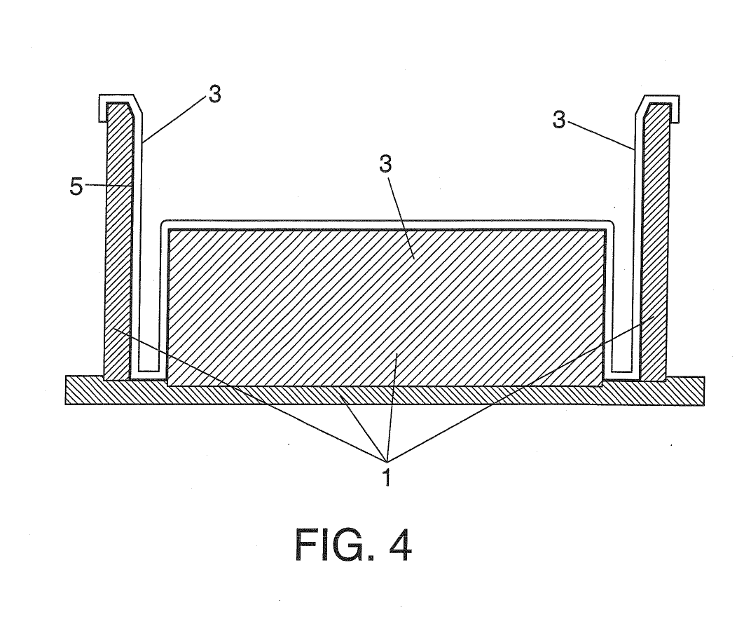

A variant of the mold used in the method is illustrated in FIG. 4, in which the mold 1 additionally comprises an inner sleeve 5 which is adjusted inside the mold and on which the film 3 is applied. In this embodiment the sleeve 5 is manufactured from a completely rigid material (steel, aluminium, duralumin, plastic, wood, etc), preferably carbon steel, but it can be made with the same materials with which the mold is made. In this embodiment, when vibration and compression have already been applied on the molding mass, the inner sleeve which still has the uncured mass, is removed from the mold. The inner sleeve 5 is then introduced in the oven to cure the mass.

This embodiment of the method allows recovering the mold for a new pressing due to the fact that when the mass is cured directly in the mold, the latter cannot be recovered until after 2 or 3 hours necessary for hardening the mass.

Two other main advantages of this embodiment are, on one hand the cost saving in molds, since the production capacity increases without having to invest in molds and, on the other hand, a short firing time in the oven, since when the sleeve 5 is removed from the mold, the heat transmission is much quicker and does not occupy as much volume as when the curing is performed inside the mold 1.

The products obtained by means of the method are preferably bathroom or kitchen items or pieces of furniture, such as sinks, washbowls, shower trays, counters, etc.

According to the described method, an example thereof, which does not limit the present invention, is illustrated below.

### EXAMPLE

A conventional manufacturing mass with the following composition is formulated.

Orthophthalic polyester resin: 7%.

Micronized silica sand: 24%.

Quartz (0.1-0.4 mm): 11%.

Silica sand (0.6-1.2 mm): 14%.

Ground mirror (0.1-0.6 mm): 12%.

Ground glass (0.6-1.2 mm): 9%.

Ground mirror (1.2-2 mm): 23%.

White pigment: 8% (over the resin content).

Suitable additives must be incorporated to the mentioned resin in order to induce the polymerization process, for which a catalyst, an accelerator and additionally a coupling agent, ultraviolet filters or antimicrobial agents are added to it.

Once the material has been correctly homogenized, it is poured onto the mold, the entire free volume thereof being covered. The assembly is then introduced in the vacuum chamber of the press, the latter is lowered to close the volume in which the vacuum is to be made, and the pump is operated, allowing 3 minutes to elapse until the desired vacuum is reached, in this case 4 mmHg. The material is then subjected to vibrocompression, such that a pressure of 7 bar and a vibration of 3400 rpm are applied for 4 minutes. After this time, the chamber of the press is opened and the mold is extracted, which mold is taken to the oven, in which it is subjected to a temperature of 90° C. for 2 hours. Finally, the hardened element is calibrated and polished.

In view of this description and set of figures, the person skilled in the art will understand that the embodiments of the invention which have been described can be combined in many ways within the object of the invention.

1. Method for manufacturing non-flat agglomerated stone products, characterized in that it comprises:
providing a mold which is open at the top and which has an inner surface;
covering the inner surface of the mold with a material preventing the direct contact of the manufacturing mass with the mold;
discharging a molding mass consisting of particles of at least an aggregate and an organic binder into the mold;
subjecting the mold to vacuum for the purpose of extracting the occluded air in the mass;
applying pressure and vibration to the mass to continue extracting the air and compacting the mass;
inducing the polymerization of the assembly; and,
extracting the formed product.

2. Method for manufacturing non-flat agglomerated stone products according to claim 1, characterized in that the inner surface of the mold defines the shape of the non-flat product to be obtained and wherein the mold is configured such that the product is shaped in a reverse manner inside the mold.

3. Method for manufacturing non-flat agglomerated stone products according to claim 1, additionally comprising the step of calibrating and polishing the obtained product after it is extracted.

4. Method for manufacturing non-flat agglomerated stone products according to claim 1, characterized in that the material preventing the direct contact of the manufacturing mass with the mold is a demolding agent in the form of a film.

5. Method for manufacturing non-flat agglomerated stone products according to claim 1, characterized in that the mold additionally comprises a rigid inner sleeve which is placed and adjusted inside the mold and on which the demolding agent is applied.

6. Method for manufacturing non-flat agglomerated stone products according to claim 5, characterized in that the demolding agent is a film.

7. Method for manufacturing non-flat agglomerated stone products according to claim 4, wherein the film is manufactured from a material which is selected from the group comprising elastomers, polymers or paper.

8. Method for manufacturing non-flat agglomerated stone products according to claim 6, characterized in that the inner sleeve is manufactured from wood, metal or stone.

9. Method for manufacturing non-flat agglomerated stone products according to claim 1, characterized in that the molding mass has an organic binder content of 6 to 15%.

10. Method for manufacturing non-flat agglomerated stone products according to claim 1, characterized in that the organic binder is a polyester, epoxy, polyurethane, vinyl ester resin or an acrylic resin.

11. Method for manufacturing non-flat agglomerated stone products according to claim 1, wherein the composition comprises at least two manufacturing masses of a different color.

12. Method for manufacturing non-flat agglomerated stone products according to claim 1, wherein the mold is manufactured from wood, metal or stone.

13. Non-flat agglomerated stone product obtained according to the method of claim 1.

14. Non-flat agglomerated stone product according to claim 13, wherein the product is a kitchen or bathroom item or piece of furniture, suitable for indoor or outdoor use.

15. Non-flat agglomerated stone product according to claim 14, characterized in that the resin used must be resistant to ultraviolet radiation, as well as to the inclemency of the weather and thermal variations used when the product must have an outdoor use.

16. Agglomerated stone product according to claim 14, wherein the bathroom or kitchen item or piece of furniture is a sink, a washbowl, a shower tray, bathtub or a counter.
